(19) United States
(12) Patent Application Publication
(10) Pub. No.: US 2008/0028732 A1
(43) Pub. Date: Feb. 7, 2008

(54) Air filter system and air cleaning method

(75) Inventors: Volker Bauer, Sindelfingen (DE); Rolf Fichter, Fellbach (DE); Ralf Widmann, Stuttgart (DE)

Correspondence Address: HARNESS, DICKEY & PIERCE, P.L.C., P.O. BOX 828, BLOOMFIELD HILLS, MI, 48303, US

(73) Assignee: LTG AKTIENGESELLSCHAFT, Stuttgart (DE)

(21) Appl. No.: 11/888,867

(22) Filed: Aug. 2, 2007

(30) Foreign Application Priority Data
Aug. 4, 2006 (DE) 10 2006 036 480.5

(51) Int. Cl. B01D 46/38

(52) U.S. Cl. 55/290

(57) ABSTRACT

The invention relates to an air filter system comprising at least one drum filter, the surface area of this filter being provided with a filter medium, and a suction device for cleaning the inside of the surface area, wherein a driving device displaces at least one suction element for the cleaning process in circular motions along the inside of the surface area as well as axially in the direction of the longitudinal axis of the drum filter. It is provided that the drum filter (4) is disposed with the longitudinal axis (6) extending vertically.

### FIELD

The invention relates to an air filter system comprising at least one drum filter, the surface area of this filter being provided with a filter medium, and a suction device for cleaning the inside of the surface area, wherein a driving device moves at least one suction element for the cleaning process in circular motions along the inside of the surface area as well as axially in the direction of the longitudinal axis of the drum filter.

### BACKGROUND OF THE INVENTION

Air filter systems of the kind described above are known. Particularly in industrial plants, for example in plants in the textile industry where considerabe amounts of suspended matter or dust collect, they serve the filtration of air pollutants. During the cleaning process, the air passes a face of at least one drum filter of the air filter system before it reaches the inside of the drum. From there, the air passes through the surface area of the drum filter, the area being provided with a filter medium. In this way, a filter cake is formed on the inside of the surface area, which is cleaned by suction. The suction element is therefore displaced both in circular motions along the inside of the surface area and axially in the direction of the longitudinal axis of the drum filter in order to remove the filter cake by suction. Drum filters of this type, which are disposed horizontally, are frequently combined to form a drum filter group, which is to say such a multi-drum filter comprises a plurality of drum filters disposed, for example, in a matrix fashion, wherein the longitudinal axes of the drum filters extend parallel to one another. For the above-mentioned cleaning process, each drum filter is associated with one suction element, which is displaced back and forth in the respective drum filter by means of a horizontal carriage, wherein the element performs a circular motion at the same time to perform the cleaning in a helical path. In the event of a multi-drum filter, the horizontal carriage is associated with an appropriate number of suction elements. The installation of the known air filter system requires a relatively large base area, which is then not available for other purposes and therefore a cost factor.

### SUMMARY OF THE INVENTION

It is therefore the object of the invention to provide an air filter system of the kind described above, the system being space-saving and economical.

This object is achieved according to the invention in that the drum filter is disposed with a vertically extending longitudinal axis. This configuration has the advantage that the base area required by the drum filter is relatively small and is not increased by the fact that a lateral zone must be provided so as to install the driving device for the suction element and create operating space for the back and forth displacement of the driving configuration of the suction element, since this zone according to the invention is available above the drum filter and therefore does not require any additional base area. The base area of the drum filter is rather used twofold in that on the one hand the drum filter is installed there and that on the other hand the above-mentioned zone is formed above the drum filter. The space above the drum filter, which was previously not utilized, is used for the purpose according to the invention, which becomes possible by installing the drum filter no longer horizontally, as is found in the state of the art, but instead standing, which is to say with a vertical longitudinal axis.

According to a further development of the invention, it is provided that the suction element is disposed on an elongated element extending along the longitudinal axis of the drum filter. This elongated element serves the mechanical retention of the suction element and offers the possibility of moving axially accordingly far into the interior of the drum filter in order to access all areas requiring cleaning on the inside of the surface area of the drum filter.

According to a further development of the invention, it is provided that the elongated element is disposed rotatably about the longitudinal axis thereof on a carriage of the cleaning device, wherein the carriage is mounted vertically displaceably. The suction element is guided on a circular path by rotating the elongated element about the longitudinal axis thereof. As a result of a displacement of the carriage, the suction element is displaced axially inside the drum filter. A rotation of the elongated element displaces the suction element along a circular path on the inside of the drum filter. The configuration may be such that the two motions are superimposed, creating a helical movement. Alternatively, it is also possible to decouple the rotatory movement from the axial movement (particularly based on two drives, wherein one implements the vertical displacement and the other the rotatory displacement) and in this way perform the cleaning operation by suction, which is to say the removal of accessible regions of the filter cake on the inside of the surface area of the drum filter. The carriage is mounted vertically displaceably, so that the space above the drum filter is utilized.

According to a further development of the invention, it is provided that the driving device comprises a spindle drive for the axial displacement. The spindle of this spindle drive runs vertically to be able to displace the carriage vertically up and down. A carrier element (latch) provided with an internal thread is disposed on the threaded spindle of the spindle drive and as a result of the rotation of the spindle performs a vertical movement, in this way carrying the carriage and displacing it accordingly.

According to a further development of the invention, it is provided that the spindle motor of the spindle drive is disposed stationary, which is to say it has a fixed position on the machine frame and consequently is not displaced together with the carriage or other moving parts of the air filter systems.

According to a further development of the invention, it is provided that the driving device comprises a rotary drive for the circular motion. The rotary drive is rotatably coupled to the preferably elongated elements, so that at least one suction element provided on the rotatable element can perform a rotatory movement. The rotary driving motor of the rotary drive is preferably disposed on the carriage, which is to say it is displaced with the vertical movement of the carriage. The spindle motor and rotary driving motor are preferably configured as electric motors. Alternatively, it is also possible that the suction element is installed such that it is fixed in place and that the drum filter moves (rotatory and vertical displacements). Hybrid configurations are also conceivable, meaning the suction element performs one movement (for example the vertical movement) and the drum filter performs the other movement (for example the rotatory movement).

According to a preferred embodiment, it is provided that the driving device is configured as a cross-arm spindle driving device. On the cross-arm spindle of the cross-arm spindle driving device, a carrier element (latch) is provided, which is carried along axially by the rotation of the cross-arm spindle—similar to the process with a threaded spindle—wherein, however, at the end of the cross-arm spindle a reversing motion is performed and accordingly a back and forth movement is brought about for the same direction of rotation. With respect to the subject matter of the invention, the cross-arm spindle is, of course, disposed vertically in order to move a suction element up and down in the vertically disposed drum filter. If instead of a cross-arm spindle a regular threaded spindle is used, a reversal of the direction of rotation is required for the reversing operation.

It is preferable if an inflow of air to be filtered into the lower face of the drum filter is provided. Accordingly, the air is introduced axially from beneath into the drum filter and radially passes through the surface area of the drum filter in order to separate polluted particles on the inside of the surface area of the drum filter. From there, the cleaned air can be discharged axially or radially.

In particular, it may be provided that the elongated element not only serves the mechanical retention of the suction element, but is additionally configured as a hollow body and can therefore form a suction duct. The suction duct is connected to a vacuum source or the like. Furthermore, the suction element is connected to the suction duct, meaning the elongated element, so that the filter cake regions to be removed by suction are eliminated via the suction element, the elongated element and optionally a suction channel or the like by means of the vacuum source.

The suction element is preferably configured as a suction nozzle, which achieves a particularly good cleaning effect.

In particular, it is provided that the air filter system comprises a plurality of drum filters in the form of a vertical drum filter group, each of the drum filters being associated with at least one suction element. Accordingly, all drum filters are preferably disposed with the vertical longitudinal axes thereof in a row or matrix and form the aforementioned drum filter group. Each drum filter of the drum filter group is associated with a dedicated suction element, which is displaceable along the respective drum filter axis and accordingly performs a vertical movement and may also be guided along a circular path, in order to access the entire circumference of the inside of the surface area of the respective drum filter, the surface area being provided with a filter medium.

Furthermore, it is preferably provided that the suction elements are associated with a common driving device, which is to say all suction elements can be displaced simultaneously with a single driving device.

The invention furthermore relates to an air cleaning method by means of an air filter system comprising at least one drum filter, the surface area of the filter being provided with a filter medium, and a suction device for cleaning the inside of the surface area, wherein a drive device displaces at least one suction element for the cleaning process both in circular motions along the inside of the surface area and axially in the direction of the longitudinal axis of the drum filter along the inside, and wherein the drum filter is installed with the longitudinal axis extending vertically. The cleaning motion for the displacement along the longitudinal axis of the drum filter is accordingly performed vertically since also the drum filter is installed with a vertically extending longitudinal axis. As a result, an open space above the drum filter required for cleaning is formed, which in the above description was also referred to as a zone, so that no additional precious base area must be provided. Instead, the base area is used twofold in that the drum filter is installed there in a space-saving manner due to the vertical position and that above the drum filter, without requiring any further base area, the cleaning components may be disposed and operated in this zone so as to remove the filter cake.

### BRIEF DESCRIPTION OF THE DRAWINGS

The drawings illustrate the invention by way of an exemplary embodiment, wherein:

FIG. 1 is a perspective view of an air filter system,

FIG. 2 is a side view of the air filter system,

FIG. 3 is a side view of the air filter system rotated 900 in relation to FIG. 2, and

FIG. 4 is a top view of the air filter system.

### DETAILED DESCRIPTION

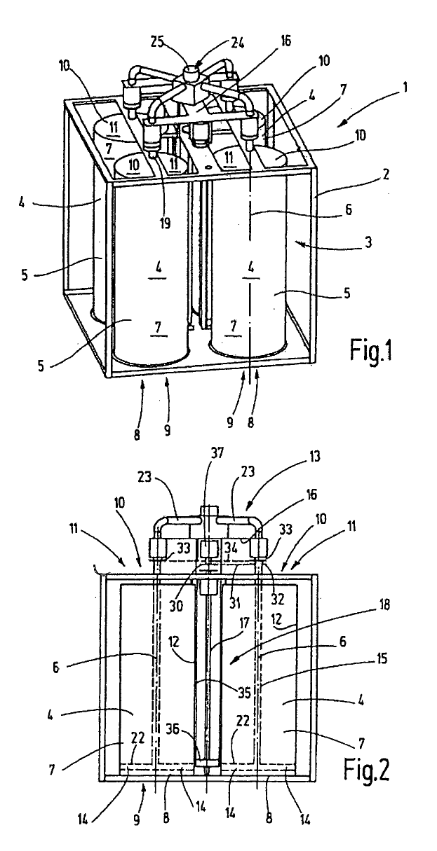

FIGS. 1 to 4 show an air filter systems 1 comprising a machine frame 2. The basic structure of the machine frame 2 is square. Inside the machine frame 2, a drum filter group 3 is disposed, which in the present exemplary embodiment comprises four drum filters 4. Each drum filter 4 has a surface area 5 extending concentrically to the central longitudinal axis 6 of each drum filter 4. The drum filters 4 are each disposed with the longitudinal axes 6 thereof extending vertically, which is to say they are installed such that they stand up and are held in this position by the machine frame 2. The surface areas 5 of the drum filters 4 are formed by filter media 7. The lower face 8 of each drum filter 4 is configured to be open, forming an inflow opening 9 for the air to be cleaned. The upper face 10 of each drum filter 4 is provided with an air-impermeable cover 11.

Air from a room or exhaust air from a machine, for example a textile machine, is fed into the inflow openings 9 by means of air conveyance and guidance means, which are not shown. The air exits radially from the surface areas 5 of the drum filters 4, wherein particles, suspended matter and the like filtered from the insides 12 of the surface areas 5 configured as filter media 7 are removed as filter cake.

A suction device 13 is provided to remove the filter cakes from the insides 12 of the drum filters 14 by means of suction. The device comprises for each drum filter 4 at least one suction element 14 (FIG. 2), wherein in FIG. 2 two suction elements 14 are provided per drum filter 4 by way of example, the elements, which are diametrically opposed from one another in relation to the longitudinal axis 6, enclosing a right angle with the longitudinal axis 6. Accordingly, the tubular suction elements 14 extend radially and rest against the insides 12 of the respective drum filters 14. The suction elements 14 are connected such that they communicate with the respective elongated element 15, which has a tubular shape and extends coaxially to the respective longitudinal axis 6. The length of each elongated element 15 is selected such that in the position of the air filter system 1 shown in FIG. 2 the suction elements 14 can reach the lower inner border area of the drum filter 4. The elongated elements 15 are mounted rotatably on a carriage 16, wherein each individual carriage 16 retains all four elongated elements 15 rotatably about the respective longitudinal axis 6.

In the center of the machine frame 2 a cross-arm spindle 17 of a cross-arm spindle driving device 18 is rotatably mounted, wherein the cross-arm spindle 17 is disposed such that it extends vertically and is axially stationary.

According to FIG. 2, the carriage 16 is mounted vertically displaceably by means of a guide 35, wherein furthermore the elongated elements 15 rotatably and displaceably penetrate openings 19 in two upper cross-bars 20 of the machine frame 2. The guide 35 extends parallel to the cross-arm spindle 17, wherein the movable part of the guide 35 at the lower end thereof is provided with a spindle nut 36 (latch) that meshes with the cross-arm spindle.

The elongated elements 15, which are connected to the suction elements 14 configured as suction nozzles 22 such that they can communicate with them, are connected to suction pipes 23 converging in a star-shaped manner above the carriage 16, the suction pipes leading to a collector 24, wherein the suction connector 25 of the collector is connected to an air conveyance device, which is not shown.

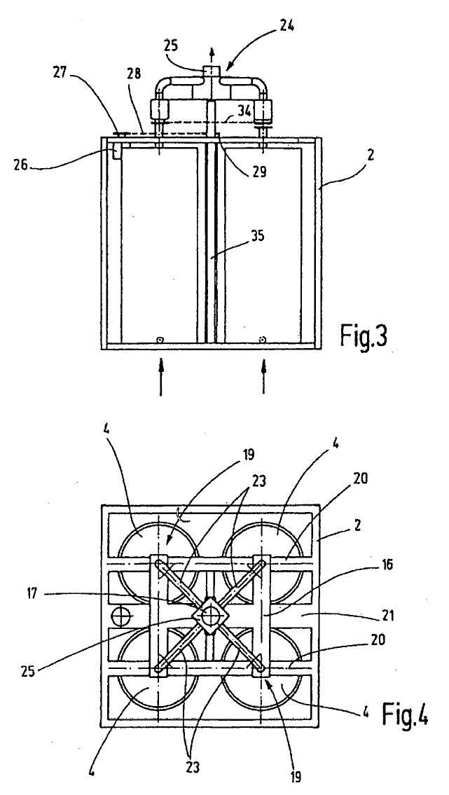

A cross-arm spindle driving motor 26 is disposed stationary on the machine frame and configured as an electric motor. Via a pulley 27 and a belt 28, the motor drives a pulley 29, which is non-rotatably connected to the cross-arm spindle 17 (FIG. 3). In this way, the cross-arm spindle 17 can be put in rotation. A further pulley 30 (FIG. 2) can be rotated by means of a rotary driving motor 37 provided on the carriage 16, wherein the pulley is coupled via a belt 31 to a pulley 32, which is disposed non-rotatably on one of the elongated elements 15. All elongated elements 15 comprise pulleys 33 (FIG. 2), around which a common belt 34 is wrapped.

This configuration produces the following function: When the cross-arm spindle driving motor 26 is switched on, the cross-arm spindle 17 starts to rotate. The spindle nut 36 meshes with the cross-arm spindle 17, causing the carriage 16 to be displaced up and down. This displacement is performed in the vertical direction. The rotary driving motor 37, which is in operation at the same time, drives all elongated elements 15 in a rotatory manner via the belts 31 and 34 and the elements are rotated about the vertical longitudinal axes 6, so that the suction nozzles 22 are displaced in a circular fashion along the insides 12 of the drum filters 4. Superimposed with these rotatory movements is the axial up and down displacement of the carriage, so that the suction nozzles 22 clean the insides 12 of the drum filters 4 along helical paths and in this way remove the filter cakes forming there.

It is clearly apparent from FIGS. 1 to 4 that the suction device, together with the associated components serving the cleaning of the surface areas 5 of the drum filters 4, are provided above the drum filters 4. Particularly when the suction nozzles 22 are displaced completely to the top, also the carriage 16 is displaced to the top, without requiring any additional base area for the air filter system 1. This demonstrates that, as a result of the open space provided on the cleaning device above the drum filters 4, the air filter system 1 according to the invention has no large base area requirement. This is due to the fact that the drum filters 4 are installed with vertically extending longitudinal axes 6.

The invention will be addressed again below in concrete details, wherein also alternatives are mentioned to the exemplary embodiment described above. The air filter system according to the invention preferably comprises a vertically disposed drum filter or a drum filter group with at least two drum filters that are disposed vertically. The air to be cleaned flows from the inside out in each drum filter 4, wherein the inflow occurs from beneath and the outflow occurs toward the top and/or side. The drum filters 4 are cleaned continuously or intermittently on the inside. Cleaning may be performed continuously, in a time-controlled and/or in a pressure-controlled manner. The cleaning operation is performed by means of a vacuum using suction units or suction elements, particularly suction nozzles, wherein at least one suction unit is provided for each drum filter 4. The cleaning process is performed in fractions inside each drum filter 4. In particular, it is provided that cleaning is performed by superimposing two motions, meaning a rotatory movement and a vertical transaxial movement. The movements can be treated and driven separately from each other. During the vertical, transaxial movement toward the top and bottom, it is preferable if the entire suction train is displaced. The vertical displacement is preferably performed via a spindle drive, which does not follow the displacing movement. The spindle is preferably driven electrically or pneumatically. It can be driven either directly or via a belt. The rotary drive is preferably provided on the vertically moving suction train. The rotational driving motion is performed by an electric motor, particularly by a geared motor. With respect to the rotary drive, it may be provided that each drum filter 4 is driven separately by belts. The power transmission via belts is preferably performed without additional coupling or tensioning elements. In particular, it may be provided that the weight of the suction unit is compensated for at least partially or almost completely by means of a counterweight guided by deflection, so that the driving power for the up and down movements is very low. On the cross-arm spindle driving device, it may be provided that only one driving motor is available, which brings about the vertical displacement as well as the rotatory displacement.

Above, belt drives were described. Instead of belt drives, it is also conceivable to use chain drives.

1-14. (canceled)

15. An air filter system comprising:
at least one drum filter, the at least one drum filter including a surface area provided with a filter medium;
a suction device for cleaning the inside of the surface area; and
a driving device displacing at least one suction element for the cleaning process in circular motions along the inside of the surface area and axially in the direction of the longitudinal axis of the drum filter;
wherein the drum filter has a vertically extending longitudinal axis.

16. The air filter system according to claim 15, wherein the suction element is disposed on an elongated element which extends along the longitudinal axis of the drum filter.

17. The air filter system according to claim 15, wherein the elongated element is mounted rotatably about the longitudinal axis on a carriage of a cleaning device, the carriage being mounted vertically displaceably.

18. The air filter system according to claim 15, wherein the driving device comprises a spindle drive for axial displacement.

19. The air filter system according to claim 15, wherein the spindle drive includes a spindle motor disposed in a stationary manner.

20. The air filter system of claim 19, wherein the spindle motor is a cross-arm spindle motor.

21. The air filter system according to claim 15, wherein the driving device comprises a rotary drive for the circular motions.

22. The air filter system according to claim 17, wherein the driving device comprises a rotary drive for the circular movements, and wherein a rotary driving motor of the rotary drive is disposed on the carriage.

23. The air filter system according to claim 15, wherein the driving device is a cross-arm spindle driving device.

24. The air filter system according to claim 15, wherein the drum filter includes a lower face for receiving air to be filtered.

25. The air filter system according to claim 16, wherein the elongated element serves as a suction duct.

26. The air filter system according to claim 15, wherein the suction element is a suction nozzle.

27. The air filter system according to claim 15, wherein the at least one drum filter includes a plurality of drum filters combined to form a vertical drum filter group, at least one suction element being associated with each drum filter.

28. The air filter system according to claim 27, further comprising a common driving device associated with the suction elements.

29. An air cleaning method using an air filter system at least one drum filter, the surface area of the filter being provided with a filter medium, and a suction device for cleaning the inside of the surface area, a driving device displacing at least one suction element for the cleaning process both in circular motions along the inside of the surface area and axially in the direction of the longitudinal axis of the drum filter, the drum filter being installed with the longitudinal axis extending vertically.
